(19) United States
(12) Patent Application Publication
(10) Pub. No.: US 2008/0087377 A1
(43) Pub. Date: Apr. 17, 2008

(54) Method for Coating a Substrate Using a Paint Intensifier and Method for Bonding Coated Parts

(75) Inventors: Norman Blank, Rueschlikon (DE); Urs Burckhardt, Zuerich (CH); Peter Gimmnich, Konstanz (DE); Michael Hilt, Korb (DE); Gunter Kranz, Altdorf (DE); Stefan Lotz, Gaeufelden (DE); Josef Michel, Ulm (DE)

Correspondence Address: AKERMAN SENTERFITT, P.O. BOX 3188, WEST PALM BEACH, FL, 33402-3188, US

(73) Assignees: DAIMLERCHRYSLER AG, STUTTGART (DE); SIKA TECHNOLOGY AG, BAAR (CH)

(21) Appl. No.: 11/721,370

(22) PCT Filed: Dec. 9, 2005
(86) PCT No.: PCT/EP05/13250

§ 371 Date: Aug. 31, 2007

(30) Foreign Application Priority Data
Dec. 10, 2004 (DE) 10 2004 059 689

(51) Int. Cl. B29C 65/00; B05D 3/06

(52) U.S. Cl. 156/273.3; 156/60; 427/340

(57) ABSTRACT

The invention relates to a method for coating a substrate by means of a paint system, said system comprising at least two paint layers, which are applied in succession to the substrate. After said application, a paint enhancer or strengthener is applied to the surface of at least one of the two applied paint layers. The method permits a substrate to be coated in such a way that at least some sections of the paint system (where the paint intensifier has been applied) have an improved mechanical load-bearing capacity, in order to produce e.g. an adhesion point with an improved mechanical stability. The invention also relates to a substrate that is coated with the paint system, to joining methods for a paint system of this type, to joined connections, to the use of bonding mixtures and to multi-ply paint layers comprising areas that have been subsequently cured.

The invention concerns a process for coating a substrate with the characteristics of the pre-characterizing portion of patent claim 1, a corresponding coated substrate according to patent claim 12, a process for the permanent bonding of two parts with the characteristics of the pre-characterizing portion of patent claim 13, a bond between two parts with the characteristics of the pre-characterizing portion of patent claim 25, a use of mixtures of cross-linkable organic compounds with the characteristics of the pre-characterizing portion of patent claim 27 as well as a multi-layer paint coating with the characteristics of the pre-characterizing portion of patent claim 34. The invention can be used industrially, for example, in the automobile industry in the painting of components, such as, for example, body or components mounted to the body, as well as in adhering onto this type of coated component. For ease of explanation, the invention will be explained in the following on the basis of the above-mentioned examples.

New modular construction concepts for motor vehicles increasingly include the joining of already preformed components or modules. Therein, it is desirable for economic reasons to provide the individual modules already painted and as ready-to-use as possible. For this reason a greater significance is attached in particular to adhering, as the joining technique, for components or modules with already pre-coated, in certain cases pre- or final-painted, substrates. Particularly of interest is the processing of completely pre-painted sheets in modular construction techniques.

In painting, varying paint systems occur with various layers of paint. In motor vehicles, in association with the above-mentioned modular manner of construction, the following paint systems, among others, are of significance:

1. With metallic substrates, for example, sheets:

substrate/weldable corrosion protective layer/CDC-coating/functional layer/base paint/clear coat
substrate/weldable corrosion protection layer/CDC-coating/functional layer/base paint
substrate/weldable corrosion protection layer/CDC-coating/base paint with filler function/clear coat
substrate/weldable corrosion protection layer/base paint/clear coat
substrate/corrosion protection layer/adhesive/paint film (carrier film with base paint and clear coat)
   Therein the term “CDC-coating” refers to coatings applied by means of cathodic dip coating. The clear coats are, as a rule, thermal cured or hardened systems; UV-hardened systems are however also possible. A paint layer, which does not form the outer-most paint layer of a paint system, is referred to in the framework of the present invention as “intermediate paint layer”. The outermost paint layer is referred to as “cover paint layer”.
   2) In the case of plastic substrates:
substrate/primer layer/base layer/clear coat
substrate/base paint/clear coat
substrate/primer layer/paint film (carrier foil with base paint and clear coat)

A problem with the adhering of modular components is, among other things, the sometimes insufficient toughness of the paint layers of conventional paint systems. Thus, in the case of conventional paint systems, adhered bonds tear to some extent on the substrate surface following application of mechanical loads, and, in the case of multilayer paint systems, frequently also within a paint layer before reaching the desired mechanical load. One possible solution is comprised in removing the finished paint layers in the areas to be adhered using supplemental work steps, in order to carry out the adhesion directly to the substrate, whereby a mechanically relatively highly loadable adhesion site is achieved. As an alternative solution, in the painting process the application of paint is prevented by masking initially, in order to produce bare or unpainted areas in the area to be adhered, such that adhesive can be applied directly upon the substrate to achieve a bond with high mechanical toughness. The disadvantage of this known process is, foremost, in the time-consuming labor. Further, it is difficult in the case of the removing process to maintain the CDC-coating in functional condition (corrosion protection).

In consideration of the above, it is the task of the present invention to provide a process for coating, with which in simple manner a substrate can be obtained coated with a paint system, which exhibits at least in certain areas an increased load bearing capacity or toughness, such that in this area in simple manner, for example, an adhesion location can be produced with improved mechanical strength or durability.

A further task of the present invention concerns providing a substrate coated with a mechanically stable paint system.

It is a further task of the invention to provide a mechanically more stable adhesion site (without changing the paint formulation) and a simple and economical process suited for this.

These tasks are solved by the subject matter defined in the claims. Preferred embodiments are set forth in the dependent claims.

A first embodiment of the present invention is accordingly a process for coating a substrate with a paint system, wherein the paint system includes at least two paint layers, which are applied sequentially upon the substrate. In accordance with the invention, following the application of at least one of the two paint layers, a means for enhancing at least one of the paint layers of the paint system (in short: paint enhancer or paint strengthener, these terms being used interchangeably) is applied upon the outer surface of the applied paint layer.

The term “substrate” in the framework of the present invention is, for simplification, to be understood as encompassing not only substrates in the conventional sense but rather also conventional substrates with thereupon applied corrosion protection layers and/or CDC-layers.

The term “means for enhancing a paint layer” (in short: paint enhancer means) is understood within the framework of the present invention as referring to means which supplementally enhance the mechanical rigidity of an applied paint layer by further chemical curing. The strengthening or enhancing or reinforcing or, as the case may be, further chemical curing can be brought about in that the paint enhancer operates in the manner of a cross-linking agent and, after diffusion into or, as the case may be, penetration into the paint, covalently and/or non-covalently links or bonds or, as the case may be, cross-links the paint macromolecules of the partially or fully cured paint binder three dimensionally. The re-enforcement or, as the case may be, further chemical curing can also be caused in that the paint enhancer, following diffusion into or, as the case may be, penetration into the paint, forms, in the already existing macromolecular network of the partially or through-cured paint binder, an interpenetrating network (also refer to as “penetrating-through network”). Preferred are paint enhancers which work in the manner of a networking agent. The term “paint enhancer” is understood in the framework of the present invention as in including paint hardeners. In the case of paint enhancers, these are preferably a reactive chemical compounds or a combination of two or more reactive chemical compounds. The paint enhancer can comprise one component or multiple components, as described in greater detail in the following.

The inventive process makes it possible to coat a substrate in simple manner with a paint system, which at least in areas (in the area of the application of the paint enhancer) exhibits an improved mechanical hardness, without requiring the composition of the employed paint of the different paint layers to be laboriously reformulated or adapted. These types of paint systems prepared in simple manner are suited in particular for areas, which are intended as adhesion sites. Adhesions or bonds at this type of adhesion site exhibit among other things an improved crash survivability or, as the case may be, an improved crash behavior. The cured paint systems produced in accordance with the invention do not, as a rule, require any further preparation prior to adhering, however, could never-the-less if desired be primed, for example, in the area of the outer layer. For adhering it is not necessary for example to remove paint layers, rather, bonding or adhering can take place directly on the paint system produced in accordance with the invention. It is further not necessary to prevent application of paint in an intended adhesion site by the labor intensive application of the mask prior to painting, since in accordance with the inventive process essentially higher stiffness of the adhered laminate or bond is achieved than had been possible until now.

The inventive process can be further enhanced in that a paint enhancer is employed, which contains at least one cross-likable chemical compound, which penetrates at least one of the paint layers and brings about the strengthening of the paint layer into which it perfuses or through which it penetrates. Since in the case of the employment of multiple cross-linkable chemical compounds their coefficients of diffusion must be coordinated to each other, it is advantageous, when the paint enhancer contains only one of this type of cross-linkable chemical compound and, in particular, is formulated as a single component. Therein it is preferred when the employed cross-linkable chemical compounds penetrate in all paint layers through to the CDC and thereby penetrate through at least one paint layer (in particular the paint layer with the lowest mechanical stability), or the cross-linkable chemical compounds in fact penetrate through all paint layers. Thereby the mechanical stability of the paint system can be further improved.

At this point it can be mentioned, that the diffusion co-efficient of a chemical compound is dependent upon the Fick's Second Law of Diffusion in conjunction with the Einstein relation of, among other things, the geometric configuration of the molecules of the chemical compound and therewith—in rough approximation—is dependent upon the molecular weight. For the present invention this means that cross-linkable chemical compounds with a high co-efficient of diffusion or, as the case may be, a low molecular weight, are preferred, since this type of cross-linkable chemical compound advantageously diffuses rapidly and deep into the paint layers, upon which they are applied, before they cross-link and thereby lose their mobility. The molecular weight of suitable cross-linkable chemical compounds lies preferably in the range of 500 g/mol or thereunder.

Upon application of the paint enhancer upon a paint layer in the partially dried condition molecules with higher molecular weight could also be suitable, since then the diffusion can occur in the liquid condition, at least however in the un-cross-linked or uncured condition of the paint layer, which enhances and accelerates the penetration of the paint enhancer. The easier the paint enhancer can penetrate into the paint layer or the paint system, the more beneficial the effect with regard to the time requirement of the inventive process.

Therein it is preferred, when the at least one cross-linkable chemical compound of the paint enhancer, which one employs, is an organic compound capable of a poly-reaction. A poly-reaction could be a polymerization reaction, or a poly-addition reaction or a poly-condensation. The employment of this type of chemical compounds has the advantage that they exhibit a large structural variety and, for example, also variations in their functional or, as the case may be, reactive groups, and can in simple manner be extensively adapted to the special requirements of their employment.

In this context cross-linkable chemical compounds with at least two cross-linkable groups are suitable when the cross-linkable chemical compound operates in the manner of a cross-linker, or as the case may be, should work, or with at least one cross-linkable group, when the cross-linkable chemical compound forms an interpenetrating network, or as the case may be, should form, that is, cross-links with itself, for example (meth)acrylate, cyanacrylate, alkoxysilane or multi-functional isocyanate (in the case that no reaction-capable double bonds are present in the paint binder). The cross-linkable groups are therein so selected, that the cross-linkable chemical compounds, as single component system, form networks with themselves within the paint layer and/or can couple to the existing, not yet reacted groups of the paint (for example OH—, NH—groups, C═C-double bonds, epoxide groups) and therewith supplementally cross-link the paint layer.

Examples of suitable cross-linkable groups are ethylenic unsaturated groups such as acrylate groups, (meth)acrylate groups, cyanacrylate groups, isocyanate groups or carbodiimides, as well as blocked or masked isocyanate groups, hydrazine groups, methylol groups, epoxide groups or alkoxy silyl groups, as well as similar addition reaction undergoing groups, or combinations of such groups.

The cross-linkable chemical compounds therein carry, as a rule, two or more of the above mentioned cross-linkable groups in one molecule, and as such they could carry multiple similar and/or different cross-linkable groups in one molecule.

The term “mono-functional” is this document refers to a compound which exhibits only one of the above mentioned functional groups, while “multi-functional” means that a compound exhibits two or more of the respective functional groups. Thus, for example, tetrahydrofurfuryl 2-(meth)acrylate is characterized as a mono-functional (meth)acrylate while dipropyleneglycol-diacrylate and trimethylpropane-triacrylate are examples of multi-functional acrylates.

Particularly suitable cross-linkable organic compounds are selected from the following groups J) through VIII):
I) Organofunctional alkoxysilanes of the general Formula 1), or oligomers thereof:
   Y—R³—Si(R²ₙ)—OR¹₍₃₋ₙ₎ (1),
   wherein
   n=0 or 1;
   Y=a residue selected from the group including CH═CH₂, NH₂, NHR⁴, NHC(O)OR⁴, N═C═O, SH, SR⁴, OR⁴, OC(O)R⁴, OC(O)CH═CH₂, OC(O)C(CH₃)═CH₂ and 2,3-epoxypropoxy;
   R¹=alkyl groups with 1 to 5 C-atoms, which optionally contain an ether-oxygen, preferably methyl, ethyl, iso-propyl or methoxyethyl;
   R²=alkyl groups with 1 to 8 C-atoms, preferably methyl or ethyl;
   R³=linear or branched, in certain cases cyclic, alkylene groups with 1 to 12 C-atoms, optionally with aromatic components, and optionally with one or more heteroatoms, in particular nitrogen atoms;
   R⁴=unsubstituted or substituted carbohydrate residue, optionally containing at least one heteroatom, with 1 to 20 C-atoms.

Preferred alkoxysilanes of Formula (1), or oligomers thereof, are vinylsilanes such as vinyltrimethoxysilane; aminosilanes such as 3-aminopropyl-trimethoxysilane, 3-aminopropyl-dimethoxymethylsilane, 3-amino-2-methylpropyl-trimethoxysilane, 4-aminobutyl-trimethoxysilane, 4-amino-3,3-dimethylbutyl-trimethoxysilane, 4-amino-3,3-dimethylbutyl-dimethoxymethylsilane, aminomethyl-trimethoxysilane, aminomethyl-dimethoxymethylsilane, N-methyl-3-aminopropyl-trimethoxysilane, N-butyl-3-aminopropyl-trimethoxysilane, N-butyl-3-aminopropyl-dimethoxymethylsilane, N-cyclohexyl-3-aminopropyl-trimethoxysilane, N-cyclohexyl-3-aminopropyl-dimethoxymethylsilane, N-phenyl-3′-aminopropyl-trimethoxysilane, N-cyclohexyl-aminomethyl-trimethoxysilane, N-cyclohexyl-aminomethyl-dimethoxymethylsilane, N-cyclolhexylaminomethyl-triethoxysilane, N-phenyl-aminomethyl-trimethoxysilane, N-phenyl-aminomethyl-dimethoxymethylsilane, N-(2-aminoethyl)-3-aminopropyltrimethoxysilane. N-(2-aminoethyl)-3-aminopropyldimethoxymethlylsilane or Bis-(3-(trimethoxysilyl)-propyl)amine: carbamatosilanes such as N-(3-trimethoxysilyl-propyl)-O-methylcarbamate, N-(dimethoxymethyl-silylmethyl)-O-methylcarbamate or N-(trimethoxy-silylmethyl)-O-methylcarbamate; isocyanatosilanes such as 3-isocyanatopropyl-trimethoxysilane, 3-isocyanatopropyl-dimethoxymethylsilane, isocyanatomethyl-trimethoxysilane or isocyanatomethyl-dimethoxymethylsilane; trimers of isocyanatosilane type isocyanuratosilanes such as tris-[3-(trimethoxysilyl)propyl]-isocyanurate; mercaptosilanes such as 3-mercaptopropyl-trimethoxysilane or 3′-mercaptopropyl-dimethoxymethylsilane; thiocarboxylatosilanes such as 3-octanoylthio-1-propyltrimethoxysilane; acrylsilanes such as 3-acryloxypropyl-trimethoxysilane; methacrylsilanes such as 3-methacryloxypropyl-trimethoxysilane, 3-methacryloxypropyl-dimethoxymethylsilane, methacryloxymethyl-trimethoxysilane, methacryloxymethyl-triethoxysilane, methacryloxymethyl-dimethoxymethylysilane, methacryloxymethyl-triethoxysilane or methacryloxypropyl-dimethoxymethylsilane; epoxysilanes such as 3-glycidyloxypropyl-trimethoxysilane or 3-glycidyloxypropyl-dimethoxymethylsilane; as well as the analogs of the mentioned alkoxysilanes with ethoxy-, isopropoxy- or methoxyethoxy groups in place of the methoxy groups on the silicon.
Particularly preferred alkoxysilanes are 3-isocyanatopropyl-trimethoxysilane, 3-isocyanatopropyl-triethoxysilane, 3-mercatopropyl-trimethoxysilane, 3-mercatopropyl-triethoxysilane, 3-octanoylthio-1-propyltriethoxysilane, 3-aminopropyl-trimethoxysilane, 3-aminopropyl-triethoxysilane. N-(2-aminoethyl)-3-aminopropyltrimethoxysilane und tris-[3-(trimethoxysilyl)propyl]-isocyanurate.
The mentioned Alkoxysilanes have as a rule a low viscosity as well as an advantageously high co-efficient of diffusion.
α-Alkoxysilanes with R³=—CH₂— (methylene) exhibit in combination with an electron pushing residue Y, such as for example, —OR⁴, —NHR⁴ or SH, an elevated reactivity in comparison to the corresponding γ-alkoxysilanes with R³=propylene or alkoxy substituted propylene. The polymerization or cross-linking reaction induced by moisture runs particularly quickly in the α-Alkoxysilanes (manufactured by Wacker).
Acryl or methacrylsilanes can be co-polymerized for example as co-monomers with (meth)acrylates of the paint system and, following hydrolysis of the alkoxy groups, can be supplementally cross-linked by condensation.
Amino silanes or mercaptosilanes can be converted or transformed with not yet reacted isocyanate groups of paint components of a not fully cured or hardened paint layer or, as the case may be, can serve for modification of isocyanate containing low molecular paint enhancer additives, whereby, besides the cross-linking possibility via the isocyanate groups, also with the aid of the alkoxysilane groups in the presence of moisture a further possibility for supplemental crosslinking exists.
Isocyanatosilanes can form independent networks in the presence of moisture via their not yet reacted isocyanate and/or alkoxy groups. In the presence of primary or secondary amino groups or hydroxyl groups in the paint these can be used for supplemental covalent cross-linking of the paint binder agent.
II) Mono- or multifunctional (meth)acrylates.
   Preferred monofunctional (meth)acrylates are tetrahydrofurfuryl-2-(meth)acrylate (THF-(meth)acrylate) and isobornyl(meth)acrylate.
   Preferred multifunctional (meth)acrylates are dipropyleneglycol-diacrylate, tripropyleneglycol-diacrylate, tricyclodecanedimethanol-diacrylate, ethoxylalated bisphenol-A-diacrylate, ethoxylated bisphenol-A-dimethacrylate, trimethylolpropane-trimethacrylate, trimethylpropane-triacrylate, tris(2-hydroxyethyl)-isocyanurate-triacrylate, ethoxylated trimethylolpropane-triacrylate, di-trimethylolpropane-tetraacrylate, pentaerythritol-tri- or -tetra-acrylate, dipentaerythritol-tetraacrylate, dipentaerythritol-pentaacrylate.
   Particularly preferred are also mixtures of mono- and multifunctional (meth)acrylates such as mixtures of various multifunctional (meth)acrylates, in particular of di(meth)acrylates (dipropyleneglycol-diacrylate, tripropyleneglycol-diacrylate and tricyclo-decanedimethanol-diacrylate) and tri(meth)acrylates. Particularly suited are such mixtures, which thermally cure at the assembly line painting temperatures (in the range of 130 to 155° C.) in the presence of atmospheric oxygen, in particular following application upon intermediate paint layers, and further exhibit low vaporization rates and at the same time impart high mechanical strength. The employment of mixtures of di(meth)acrylates and tri(meth)acrylates has, among other things, the advantage, that higher mechanical strengths are achievable than with pure (unmixed) (meth)acrylates. Particularly preferred are mixtures of dipropylenglycol-diacrylate/trimethylol-propane-trimethacrylate, tricyclodecanedimethanol-diacrylate/trimethylolpropane-triacrylate, tricyclodecanedimethanol-diacrylate and ethoxylated(3)trimethylolpropane-triacrylate.
III) Multifunctional isocyanates (polyisocyanates), for example, 1,6-hexanediisocyanate (HDI), isophorondiisocyanate (IPDI), dicyclohexylmethyldiisocyanate (H₁₂-MDI) or oligomers of these plyisocyanates, such as masked forms of these or further polyisocyanates, for example with methylethylketoxim, diethylmalonate, 3,5-dimethylpyrazol or caprolactam masked polyisocyanate, or self-networking masked polyisocyanates.
   Blocked isocyanates have, among other things, the advantage that they can be applied in the presence of water and can be linked to not yet reacted functional groups of the paint binder agent (such as NH, OH), in order to bring about a reinforcement of the paint. Self polymerizing masked isocyanates have the supplemental advantage, that the reaction partner is to a large extent built into the same molecule and thereby in principle the “optimal molar relationship” can be maintained over the entire diffusion depth. Further, the final curing is strongly accelerated relative to pure moisture cured 1K-Systems.
   Examples for suitable blocked self networking isocyanates include Bayhydrol® VP LS 2153, VP LS 2313/1, VP LS 2378, which are available as dispersions. Since the molecular relationship of the internal OH-groups is higher than that of the isocyanate groups becoming free, it could in these cases be useful, for further increasing the mechanical rigidity, to mix in for example a further masked isocyanate without OH-groups (for example the easily emulsifyable Type Bayhydur® BL 5140). The goal would be optimized self networking blocked isocyanates as 1K-Systems with equimolar amounts or slight excess of isocyanate.
IV) Cyanoacrylates such as, for example, cyanoethylacrylate and the like or mixtures thereof.
   This class of compounds has the advantage that, due to their low molecular weight and viscosities, they exhibit very good diffusion characteristics and can be employed as a one component system. Cyanacrylates are in particular suited for employment on through-hardened paint systems.
V) Multifunctional hydrazides such as, for example, carbodihydrazide or adipic acid dihydrazide.
   This class of compounds has multiple advantages: they can be employed for example as a one component system, are soluble in water and can be employed without protective or masking groups (which is in particular advantageous in the application upon the partially dried, aqueous paint layers) and readily react with carbonyl functionalities upon removal of water, which functionalities are present in many paints, forming network systems. This reaction can advantageously also be used for supplemental networking of through-hardened or cured paint systems.
VI) Multifunctional carbodiimides such as, for example, poly-(1,3,5-triisopropyl-phenylene-2,4-carbodiimide).
   These compounds can be advantageously employed as cross-linkable chemical compounds of paint-binders with amino groups and/or carboxylate groups. Their advantage lies for example therein, that they can be diluted with water, can be employed at room temperature and do not release any volatile cleavage products or volatile organic chemicals (VOC).
VII) Multifunctional epoxides, for example, bis-(2,3-epoxycyclopentyl)ether, polyglycidylether of multifunctional aliphatic and cycloaliphatic alcohols such as 1,4-butanediol, polyethyleneglycols, polypropyleneglycols and 2,2-bis-(4-hydroxycyclohexyl)-propane-polyglycidylether of multifunctional phenols such as resorcinol, bis-(4-hydroxyphenyl)-methane (Bisphenol-F), 2,2-Bis-(4-hydroxyphenyl)-propane (Bisphenol-A), 2,2-bis-(4-hydroxy-3,5-dibromophenyl)-propane, 1,1,2,2-tetrakis-(4-hydroxyphenyl)-ethane and condensation products of phenols with formaldehyde, which are obtained under acidic conditions, such as phenol novolaks and cresol novolaks; polyglycidylesters of multifunctional carbonic acids such as phthalic acids, terephthalic acids, tetrahydrophthalic acids and hexahydrophthalic acids; N-glycidyl-derivates of amines, amides and heterocyclic nitrogenous bases such as N,N-diglycidylaniline, N,N-diglycidyltoluidine, N,N,O-triglycidyl-4-aminophenol, N,N,N′,N′-tetraglycidyl-bis-(4-aminophenyl)-methane, triglycidylcyanurate or triglycidylisocyanurate.
   Preferred are hexanediol-diglycidylether poly-propylenglycol-diglycidylether and polyethylenglycol-diglycidylether.
   Epoxides have the advantage, that in principle a very high mechanical strength can be achieved. As a rule two components are necessary (for example epoxide plus amine, or epoxide plus carbonic acid). For the employment as paint enhancer a less than stoichiometric amount of hardener component is recommended, in order to achieve yet another covalent bonding to the paint system (NH-groups, COOH-groups). Expoxide systems with hardening or curing temperatures of 100 to 140° C. are particularly suited for the intermediate layer application.
VIII) Multifunctional, highly reactive, partially alkylated melamine-formaldehyde resins with curing temperatures between 100 and 150° C. Preferred are low ethered, water soluble types (for example: Luwipal 073, BASF, partially methylated, 80% in butanol), which are curable as 1K-Systems and advantageously can be applied upon partially dried, water containing paint intermediate layers.
   Particularly preferred are blends of the above mentioned melamine resins with OH-functional multifunctional acrylates (for example, dipentaerythritol-pentaacrylate, one free OH-group) and diols (for example, 1,3-propanediol) as reactive diluent (for example: 10 parts Luwipal 073, 2 to 5 parts dipentaerythritol-pentaacrylate, 2.5 parts 1,3-propanediol). Herein it is particularly advantageous, that both the melamine resin as well as the acrylate can form stand-alone networks independent of each other (important in the case of different diffusion rates, insures curing of all components) and by supplemental cross-linking with each other a higher mechanical rigidity is achieved, than with a single component. OH— and/or amino groups of the paint binder can likewise be coupled to.
   The paint enhancer can, beyond this, include further components. Thus it is, for example, preferred that the paint enhancer comprises, in addition to a cross-linkable chemical compound, a vehicle, particularly in the case that the paint enhancer contains 2 or more cross-linkable chemical compounds, wherein the vehicle is preferably a volatile solvent or a mixture of volatile solvents. With a vehicle of this type the diffusion rates of the cross-linkable chemical compounds can be increased, so that these penetrate deeper into the paint system before they cross-link. Volatile solvents are solvents with a boiling point of less than 250° C. at atmospheric pressure.
   Suitable solvents are, for example, organic solvents with a boiling point between 50 and 180° C. These include for example ethylacetate, butylacetate, ethyllactate, propyleneglycolmethylether, propylenglycol-n-propylether, dipropylenglycoldimethylether, butylglycol. Propyleneglycolmethylether, propyleneglycol-n-propylether, ethyllactate and butylglycol (boiling point selectable in the range of 120 to 171° C.) have the advantage, that they are infinitely soluble in water, which is in particular an advantage in the case of employment upon partially dried water-based paint layers. Even water could be a suitable vehicle, for example in employment of self curing isocyanate dispersions.
   The paint enhancer could additionally also contain further organic solvents, some of which could serve as vehicles and others of which cause swelling of a fully cured paint system and therewith facilitate the diffusion in or the penetration of a paint enhancer. The suitable solvents include for example ketones (for example, acetone, methylethylketone), carboxylic acid esters (for example, ethylacetate, butylacetate, ethyllactate), aromatics (for example, toluol, xylol), glycols (for example, butylglycol) and ethers (for example, tetrahydrofuran, dipropylenglycoldimethylether). Preferred are ester based solvents. It is useful to so select the solvent such that the vaporization time corresponds with the diffusion time. In certain cases it could be useful to employ these solvents as a reactive component, such as for example propanediol or butanediol in combination with masked polyisocyanates.
   Depending upon the type of the paint enhancer, particularly according to the selection of the cross-linkable groups, the cross-linking or curing of the paint enhancer can be triggered or initiated thermally, by UV- or electron beam radiation or by moisture (H₂O). The preferred variant is curing with moisture (for example: cyanacrylate silanes, isocyanates) at room temperature, since the paint system is thereby only subjected to a slight thermal stress and the labor involved in the process is very small. In the case of application upon the paint intermediate layer the thermal curing is a preferred variant, to the extent that it can be thermally cured or cross-linked in the framework of the subsequent process steps.
   In certain systems initiators or, as the case may be, catalysts are employed for starting or, as the case may be, accelerating the curing. In, for example, (meth)acrylates an initiator can be useful for the thermal polymerization at temperatures below 100° C. or for UV-polymerization at room temperature. The initiators for the thermal curing are therein so selected, that they support in the presence of oxygen a good as possible curing. For this, azo-based initiators can be mentioned, such as for example 2, 2′-azobis-(2-methyl-propionitrile) (AIBN), Dimethyl-2,2′-azobisisobutyrate and on the other hand peroxide based initiators such as for example dibenzoylperoxide. A further example is catalysis of the urethane compounds from isocyanates, for example with a dibutyltindilaurate or a tin free metal carboxylate as catalyst.
   These include, on the one hand, azo-based initiators, such as for example 2,2′-azobis-(2-methyl-propionitril) (AIBN), dimethyl-2,2′-azobisisobutyrate and, on the other hand, peroxide based initiators, such as for example dibenzoylperoxide.
   If the cross-linking poly reaction is for example a poly condensation, for example of polyoxysilanes or hydrazines, then pH-regulators could be further components of the paint enhancer.
   A further component of the employed paint enhancer could be solvent enhancers, which beneficially influence the dissolution properties of the employed cross-link-able chemical compounds in the employed partially dried paint (water based), for example, facilitate a rapid mixing.
   In one preferred, particularly simple embodiment of the inventive process the paint system includes one or more intermediate paint layers and one coating layer or cover layer and the paint enhancer is applied upon the covered layer of the strengthened paint system.
   In one other preferred embodiment of the inventive process the paint system includes one or more intermediate layers and a cover layer, wherein the intermediate paint layers are cured, partially cured or uncured and the cover layer is partially cured, and wherein the paint enhancer is applied upon the partially cured cover layer. This has the advantage, that in the cured or the partially cured or the uncured paint layer (SN) the paint has not yet fully reacted, includes reactive groups, and can react chemically with the cross-linkable chemical compounds of the paint enhancer. Another advantage is that the diffusing in of the cross-linkable chemical compounds into the partially cured paint layers is facilitated or in certain cases accelerated thereby. Preferably the final curing of the paint system and paint enhancer occurs in a common process step.
   In yet another preferred embodiment of the inventive process the paint system includes one or more intermediate paint layers and one cover layer, and the paint enhancer is applied to one or more of the intermediate paint layers. The intermediate paint layer or intermediate paint layers are (during application of the paint enhancer) at most partially cured. This has the advantage, that thereby the diffusion path and therewith the penetration time of the applied paint enhancer can be shortened.
   In another variant of this embodiment the paint enhancer is supplementally applied upon the cover layer, therein this is likewise at most partially cured. This has the advantage, that there by the penetration is time is further shortened.
   In a further preferred embodiment of the inventive process the paint system includes one or more intermediate paint layers and one cover layer, and the paint enhancer is applied upon one or more of the intermediate paint layers. The intermediate paint layer or intermediate paint layers are therein not cured (at time of application of the paint enhancer). This has the advantage, that the penetration occurs in a liquid phase and is thus substantially more rapid.
   In one variant of this embodiment one applies the paint enhancer supplementally upon the cover paint layer, wherein this is likewise not cured. This has the advantage, that thereby a rapid distribution of the cross-linkable chemical compounds of the paint enhancer into the whole paint system is facilitated.
   In the inventive process one preferably employs a paint enhancer, which includes at least one cross-linkable chemical compound, which at least penetrates the cover paint layer and penetrates into all remaining intermediate paint layers, in particular penetrates through all intermediate paint layers. Thereby the mechanical stability of a paint system can be further supported.
   A second object of the present invention is a substrate coated with a paint system, which can be obtained according to the above described process.
   The substrate coated in accordance with the invention exhibits a paint system with at least an area (in the area of the application of the paint enhancer) of improved mechanical stability. This type of substrate is thus suited in particular to be directly adhered to, that is without preprocessing, wherein the adhesive location exhibits an improved mechanical load-bearing ability in comparison to the state of the art. For adhering, it is not necessary to remove any paint layers, rather, one can adhere directly onto the coating of the inventive substrate. It is also not necessary to prevent application of paint in the intended area of adhesion by labor intensive masking techniques, since a substantially higher stability can be achieved in the inventive coated substrate at the adhesion location than previously possible, which also has a desirable influence on the crash behavior and the crash survivability of this type of adhesion site. This allows new types of employment of adhesive on outer coatings and increases stability requirements. A third object of the present invention is concerned with a process for strong bonding of two parts, of which the at least one first one carries, in the area of the joining surface, a paint layer, wherein the process includes the following essential steps:
   a) application of a paint enhancer upon the painted area of the joining surface at least one first part;
   b) at least partial penetration or diffusion of the paint enhancer into the paint;
   c) post-curing of the paint in the areas treated with the paint enhancer by curing the paint enhancer by cross-linking cross-linkable chemical compounds of the paint enhancer with each other and/or with cross-linkable chemical compounds in the paint;
   d) adhering the first part to a second part, wherein the adhesive is applied upon the painted joining surface at the first part and/or upon a joining surface of the second part.
   The inventive process exhibits, in comparison to the known processes, the advantage of a very simply processing technique. Therewith it is possible to condition finished paint with a follow-up treatment in preparation for adhering, without having to modify the paint formulation. This is advantageous in particular when a paint is produced by multiple paint process steps. By this process it is avoided that the paint formula or paint processing must be adapted for each of the paint layers of the local area to be adhered.
   The inventive process exhibits, in the case of multilayer paint systems, a substantially increased shear resistance.
   The process is concerned with the joining of two parts to each other by adhesion, wherein at least one of the two parts carries a paint layer. It is also possible that both parts carry a paint layer. In this case it is then useful to treat or to condition both parts with the paint enhancer in the paint layers in the areas being joined.
   If the first part, which carries a paint layer, is a body part for a motor vehicle, then the second part to be joined, as a rule, is an add-on component not painted in the area to be joined. The second part to be joined could however, also be a painted part, for example in the case of modular parts.
   With regard to the paint layer, this is as a rule the final paint layer necessary for the intended use. In certain cases however a further overpainting could occur after the joining or bonding of the components. Even in this case the advantages of the inventive process are not lost.
   The process envisions in a first step a) the application of a paint enhancer upon the painted area of the joining surface of at least a first part. Therein the process for application of the paint enhancer depends upon the consistency. Typically the paint enhancer is a liquid, which is brushed or sprayed onto the area. In a further preferred variant, a liquid paint enhancer is incorporated into a porous carrier, which is brought into contact with the paint and transmits the paint enhancer to the surface in a locally defined manner. Thereby the running (bleeding) of the liquid paint enhancer is prevented. The paint enhancer could in a further embodiment likewise take the form of a gel, which is applied upon the surface for the transmission of the paint enhancer.
   In the next following process step b) the paint enhancer is given time in order to condition, that is, post-cure, the area. For this, the paint enhancer penetrates at least partially into the paint layer. This occurs as a diffusion process of the low molecular cross-linkable components into the paint layer. The paint enhancer includes for this purpose, besides the low molecular and cross-linkable chemical compounds, typically also facilitators and solvents. Depending upon the composition of the paint enhancer the various components penetrate equally or differentially into the paint. Therein it is of course also possible, that the composition of the paint enhancer applied to the outer surface differs from that penetrating into the paint. This concerns, for example, highly volatile solvents, which can completely or partially escape from the paint before the next process step occurs, for example, individual components in the case of multi component paint enhancer mixtures. The employment of single component systems is thus preferred.
   The next process step c) concerns the post curing of the paint. For this, the penetrated or, as the case may be, diffused-in paint enhancer is cured in the areas to be bonded. This occurs by cross-linking of cross-linkable chemical compounds of the paint enhancer to each other and/or with cross-linkable components in the paint.
   The cross-linkable chemical compounds are preferably so selected, that as single component systems they form a network within the paint system and/or are coupled to the existing reactive residual groups of the paint and can therewith post cross-link the paint layer.
   Examples of suitable cross-linkable chemical compounds are the above-described, in particular the compounds of the discussed groups I) through VII). These comprise as a rule multifunctional, low molecular weight starting molecules with the same type of reactive groups in one molecule or, as the case may be, also different cross-linkable groups as in the case of functional alkoxysilanes.
   Therein in advantageous manner the circumstance can be taken advantage of that in the cross-linking, that is the curing or hardening, of the paint, which conventionally takes place as polmerization and/or polyaddition and/or polycondensation reactions between cross-linkable groups which occurs with molecular weight compounds contained in the paint, part of the involved cross-linkable groups is not converted and thus remain active. Further the paint components as a rule carry additional cross-linkable groups, to which the cross-linkable chemical compounds of the paint enhancer can be coupled or bonded. Typical examples are ethylenic unsaturated groups, isocyanate groups, amino groups, or hydroxyl groups, epoxide groups and the like.
   It can be useful to not completely cure the paint layer, in order to retain still reactive groups for the paint enhancer and also to accelerate the diffusion into the paint layer. It is useful to thereafter carry out the final curing of the paint and paint curer in one common process step.
   During application of the paint enhancer on a fully cured paint composite, it can be useful to cure the paint enhancer and the adhesive in one common process step.
   The process step d) subsequent to c) envisions the joining of the two components using an adhesive. Therein the adhesive is applied in known manner to the area to be adhered. It is thus possible to apply the adhesive upon the area of the painted joining surface of the first part and/or upon the joining surface of the second part. The parts are brought into contact and the adhesive is cured. Depending upon the type of the adhesive this could in the case of a one component system occur as a rule thermally or with moisture. In the case of two component systems this can occur at room temperatures as in the case of non-moisture cured systems.
   One preferred application of the invention concerns multi-layer paints. The paint layer is herein built up of multiple layers, wherein these layers typically differ with respect to their physical characteristics and their chemical nature. Preferably the paint enhancer carries prior to and/or after curing additional cross-linkable groups, which are suited to cross-link with corresponding cross-linkable groups of the adhesive.
   In a preferred process embodiment the curing of the paint enhancer occurs at least partially together with the curing of the adhesive. This mean, that the step c) partially or completely occurs simultaneously with step d). Therein it is particularly preferred when, besides the curing of the paint enhancer, also a cross-linking with the adhesive occurs. Preferably following step d) essentially all cross-linkable groups of the paint enhancer have been reacted. This can occur as a result of reaction with additional components of the paint enhancer, the paint and/or the adhesive.
   Depending upon the type of the paint enhancer, in particular according to the selection of the cross-linkable groups, the cross-linking or curing of the paint enhancer can be triggered or initiated thermally, by UV- or by electron beam or by moisture. In certain systems a catalyst can be useful for initiation. In (meth)acrylates and initiator could be necessary for the thermal polymerization at temperatures below 100° C. or for UV-polymerization at room temperature. Preferred embodiments are curing by moisture, since herein the paint layer is subject to only low thermal loads or stresses and the process complexity is very low. In the case of simultaneous painting and adhering a thermal hardening or curing is preferred. The UV-curing is limited here in certain cases, since as a rule the curing of the paint must occur in deeper, substantially UV-impenetrable layers.
   For the curing of the paint layer, in certain cases for the follow-up or post curing, a minimum amount of paint enhancer in the paint layer is necessary. Nevertheless this amount must be limited in that the paint layer must be maintained as such. The characteristics of the untreated or unconditioned paint layer and the post-cured paint layer may not differ so much from each other, that the transition between these imparts brittleness and fractures or that an optically unacceptable, in particular discoloration change, occurs. A permanent swelling of the paint layer in the area of the adhesion application is to be limited.
   Preferably the paint layer in the area to be conditioned in step c), that means prior to cross-linking, takes up 5 to 45 wt. % particularly preferably 10 to 35 wt. % of its starting weight in cross-linkable chemical compounds.
   The paint enhancer can be free of solvent or can contain solvent.
   If solvent containing paint enhancers are employed, then the solvent is preferably so selected, that it is suited to swell the paint. Thereby the penetration or diffusion in of the cross-linkable chemical compounds of the paint enhancer are facilitated. Preferably the solvents are substantially completely removed prior to adhesion. Suitable solvents are set forth above.
   Preferably the process is so carried out, that the paint layer in step c) takes up 3 to 10 wt. % of its starting weight in solvent of the paint enhancer. These solvents bring about a swelling of the paint and thereby facilitate the penetration or diffusion in of the additional components of the paint enhancer. Therein it is useful to allow the paint treated with the paint enhancer to vent, in order to allow the solvent to escape from the paint, before the paint curing occurs. Particularly preferred is when the treated paint layer exhibits only traces of the solvent before the adhesion in step d) occurs.
   In multi-layered paint layers the process is preferably so carried out, that in step c) at least the outer most layer is penetrated by the curable components of the paint enhancer. This can be achieved by a suitable process time, amount or composition of the paint enhancer.
   It is particularly preferred when in the case of multi-layered paints the layers below the upper layer comprise at least 3 wt. % of their starting weight of cross-linkable chemical compounds of the paint enhancer. By the penetration and curing of the hardener in the intermediate area a substantial improvement in the toughness of the paint layers among themselves can be achieved. This demonstrates itself in advantageous manner in an elevated inter-lamellar sheer resistance. This increase in inter-lamellar sheer resistance is of great significance in conventional multi-layer paints, since the adhesion strength between the layers or, as the case may be, within the individual layers without the inventive post curing generally represents the weak point of the corresponding adhesion joint.
   Likewise, it is of advantage when the paint enhancer can penetrate to the painted substrate (or, as the case may be, the CDC-coating in the case of sheet metal substrates), in order here also to increase the adhesion toughness of the paint layer. Preferably the paint enhancers in step c) penetrate the entire paint layer to the extent that it can be detected on the surface of the first part. In this case the conventional spectroscopic methods, such as for example Raman and/or ATR-IR can be employed. Particularly practical for this are special IR-spectroscopy techniques for examining cross-sections (depth profile in the transmitted light process) and fractured surface analysis (ATR-technique) following surface peel tests or pull-shear tests.
   A fourth object of the invention is concerned with a joint formed between two parts, wherein at least one first part carries a paint layer, as can be obtained in accordance with the inventive process. The joint is essentially formed by the adhesive, the post cured paint layer as well as the two opposing surfaces of the joined components.
   The joint preferably contains at least 8 wt. % of polymerized or, as the case may be, cross-linked chemical compounds of the paint enhancer. Particularly preferred is when the joint contains 8-33 wt. % paint enhancer.
   In one particularly preferred embodiment of the invention the joint is formed between a part of an automobile body and a part mounted to the automobile body.
   A fifth object of the invention concerns the use of a composition including at least one cross-linkable organic compound selected from the group consisting of the following groups: I), II), III), IV), V), VI), VII), and VIII), as paint enhancer.
I) organofunctional alkoxysilanes of the general Formula (I):
   Y—R³—Si(R²ₙ)—OR¹₍₃₋ₙ₎ (1),
   wherein
   n 0 or 1;
   Y=a residue selected from the group including CH═CH₂, NH₂, NHR⁴, NHC(O)OR⁴, N═C═O, SH, SR⁴, OR⁴, OC(O)R⁴, OC(O)CH═CH₂, OC(O)C(CH₃)═CH₂ and 2,3-epoxypropoxy;
   R¹=alkyl groups with 1 to 5 C-atoms, which in certain cases contain an ether-oxygen, preferably methyl, ethyl, iso-propyl or methoxyethyl;
   R²=alkyl groups with 1 to 8 C-atoms, preferably methyl or ethyl;
   R³=linear or branched, in certain cases cyclic, alkylene groups with 1 to 12 C-atoms, in certain cases with aromatic components, and in certain cases with one or more heteroatoms, in particular nitrogen atoms;
   R⁴=unsubstituted or substituted carbohydrate residue, in certain cases containing at least one heteroatom, with 1 to 20 C-atoms;
II) mono- or multifunctional (meth)acrylates;
III) multifunctional isocyanates, masked multifunctional isocyanates;
IV) cyanacrylates;
V) multifunctional hydrazides;
VI) multifunctional carbodiimides;
VII) multifunctional epoxides;
VIII) partially alkylated melamine-formaldehyde resins, preferably low molecular weight water soluble types, particularly preferred are blends of partially alkylated melamine resin with OH-functional, multifunctional acrylates and dioles as reaction diluents.

These paint enhancers contain at least one cross-linkable chemical compound. In certain cases the paint enhancer additionally contains at least one solvent and/or at least one polymerization initiator and/or at least one catalyst. The molecular weight of each of the compounds individually contained in the paint enhancer preferably lies in the range of less than 500 g/mol. This applies in particular for the application upon cured paint layers. In the case of application on partially cured or uncured paint layers, the paint enhancer can also contain compounds with a molecular weight of more than 500 g/Mol.

The paint enhancer exhibits preferably a content of low molecular, cross-linkable chemical compounds in the range of 90-100 wt. %.

Preferred employed paint enhancers include cross-linkable organic compounds, as selected from the above already described groups I) through VII).

A sixth object of the invention concerns multi-layer paint composites with post cured paint layer areas.

These post cured paint layers, which in certain cases may be post cured or post cured areas, result from the following process steps and the therein employed multi-layer paints:

a) applying a paint enhancer upon the areas to be post cured;

b) penetration or diffusion in of the paint enhancer into these areas of the paint layers;

c) curing the paint enhancer by cross-linking cross-linkable chemical compounds of the paint enhancer to each other and/or with cross-linkable chemical compounds in the paint.

Preferably the post cured paint layer, that is the paint layer treated with paint enhancer, exhibits in the post cured areas an increase in tensile strength (determined according to DIN EN 1465, see illustrative Examples 5-7) of at least 20%. Typical examples exhibit an increase therein of 20-100%, in particular from 20-50%, in each case compared with the not post-cured paint layer. The testing is carried out on the final painted product.

Likewise preferred is when the post cured, that is, paint layer treated with paint enhancer, exhibits in the post-cured areas an increase in peal off or tear off resistance (determined in accordance with DIN EN 4624, see illustrative Examples 1-4) of 20-60%, in particular preferably from 20-40%, respectively with regard to the not post-cured paint layer.

Particularly good results are provided by the inventive process in multilayer paint systems which are applied by wet on wet techniques, in particular when the layers are not completely cured or, as the case may be, dried, before the paint enhancer is applied.

A further embodiment concerns the application upon wet layers in partial ventilated condition with a water content (solvent content) of greater than 10 wt. %. Thereby the diffusion rates can further accelerated.

In most cases, in particular in motor vehicle construction, it is desired, that the paint layer in the immediate vicinity of the adhesive location does not differ noticeably from the remaining paint layer, or more specifically it is desired that the entire visible paint layer possesses one continuous appearance. As a rule the influence of the paint enhancer is however not limited to the sharply delineated area of the joint of the two parts, since the paint enhancer can spread out to a certain extent. Thus, paint enhancers are preferred, which after curing do not bring about a change in the optical image or the surface texturing. This means in particular that no color changes, such as for example yellowing or bleaching, result, or no surface changes, such as waving or fracturing occur.

### EXAMPLES

The following examples concern a paint system with three layers, which are applied upon a CDC sheet, wherein the paint system has a total thickness of approximately 80 μm (of which the cover layer is approximately 40 μm). The paint layers in the illustrative example are all water based, color system “silver”. The curing (finish curing) occurs in this paint system following application of the clear coat in 30 minutes at 155° C. in a convection oven.

The variations of the paint enhancer application are categorized according to the location of application and the moisture content (point in time and process sequence) in the examples as follows:
1) on final cured surface coat;
2) Example 2.) through 4.) on partially dried paint layers (residual water content less than or equal to 110 wt. %), not yet or only partially cured;
3) Examples 5.) through 7.) on partial dried paint layers (residual water content greater than 10 wt. %), not yet cured.

The testing of the mechanical rigidity or strength, in particular the intermediate layer strength, occurred using the peel test (pull shear test) on completely painted composites. The peel tests were carried out respectively on inventive coated samples (that is, on samples in which a paint enhancer was applied in accordance with the invention), in the unaltered and partially also in the altered condition (cataplasma-test). Conventionally coated comparative samples respectively not treated with paint enhancer were used as reference there. The results of the peel tests in the inventive samples and in the comparative samples were respectively compared with each other and indicated in the following in percent.

A) Surface Pull-Off Test

The surface pull-off test was carried out in accordance with DIN EN ISO 4624. Therein a painted metal sheet was used as the sample according to the invention. Respectively one plunger of 2 cm diameter was adhered upon the painted top side of the sheet and upon the lower side of the sheet. Test adhesive: cyanacrylate (CA2256, obtainable from the company DELO); adhesive thickness: approximately 200 μn; minimum cured time: one day at room temperature; pull off speed: 10 mm/min.

B) Pull Sheer Test

The pull sheer test was carried out in accordance with DINEN1465. Sample with 45 mm; adhesive thickness 5 mm; length of overlap 12 mm; distance between clamps 110 mm; pull speed 10 mm/min. Test adhesive was a conventional room temperature curable high strength 2K-Epoxy.

C) Weathering—Cataplasma

The weathering behavior was examined after cataplasma-storage using a pull sheer test as described above. Cataplasma conditions; 7 days at 70° C. and 95% relative humidity subsequently 16 hours at −25° C. The measurement occurred following one day of acclimation in the Normklima (50% relative humidity, 23° C.).
1) Application of a paint enhancer (cyanacrylate) on a though-cured paint system with three paint layers; thin liquid ethyl cyanacrylate ethylcyanacrylate (Type 2201, obtainable from the Company DELO; viscosity 15 mPas at 23° C.) was applied in an excess (100 mg/cm²) without thinning with solvent under substantial preclusion of moisture on a substrate with through-cured paint system. The cyanacrylate was allowed to diffuse in for one day at room temperature with substantial preclusion of humidity and then the remaining still liquid excess was removed. Thereafter the sample was allowed to stand 7 days at room temperature in atmosphere for curing.

In the present case the increase of the tear factor or tear resistance a in the inventive sample of approximately 20% in comparison to the comparative samples was determined (surface pull-off test).
2) Application of a paint enhancer (masked isocyanate) upon the partially dried (residual water<10 wt. %) cover paint layer of a paint system with three paint layers:
   On the partially dried covered layer approximately 160 wt. % (weight of the solid with respect to the total weight of the paint system) masked polyisocyanate (Desmodur BL 3370 MPA, obtainable from the company Bayer) was diluted with butylacetate (polyisocyanate:butylacetatae=1:2) and sprayed on. Then it was allowed to stand for three days at room temperature, ventilated 15 minutes at 60° C. (allowed to stand at room temperature, wherein for example the solvent evaporated) and thereafter was final cured together with the coating layer for 30 minutes at 155° C.
   a) Determination of the adhesion strength by tear-off tests:
      increase in the tear-off resistance σ at the inventive sample by approximately 40% in comparison to the comparative samples (surface pull-off tests, samples unmodified).
   b) Surface fracture analysis using micro-ATR:
      paint enhancers could be detected in the second paint layer lying under the cover paint layer.
3) Application of a paint enhancer (tetraacrylate) upon the second, partially dried, partially cured paint layer (residual water<10 net. %) of a paint system with three paint layers: on the partially cured base paint layer approximately 7 t. % pentaerythritol-tetraacrylate 1:1 diluted with butylacetate (weight of the solid, based on the total weight of the paint system) with 1 wt. % initiator (2,2-azobis(2-methylbutyronitrile)), based on the tetraacrylate, was sprayed on, allowed to stand for two days at room temperature and then after application of the coating layer (clear coat) was ventilated 15 minutes at 60° C. and final cured 30 min. at 155° C.
   a) Determination of the adhesive strength by tear-off attempts:
      increase of the tear-off resistance in the inventive sample by approximately 40% in comparison to the comparative samples (surface pull off test, sample unmodified).
4) Application of a paint enhancer (isocyanatosilane) on the second, partially dried, partially cured paint layer (residual water<10 wt. %) of a paint system with three paint layers: on the partially cured paint base layer 3-isocyanatopropyl-trimethoxysilane diluted with ethyllactate (silane:ethyllactate=1:3, approximately 10 μm calculated as dry film) was sprayed on. After 60 min. standing at room temperature the cover paint layer (clear coat) was applied, ventilated 15 min. at 60° C. and final cured 30 min. at 155° C.

From the tear-off tests (surface pull-off tests of unmodified samples) an increase of 27% was found.
5) Application of a paint enhancer (acrylate mixture of di- and trifunctional acrylates) upon the intermediate layer (paint layer 1, as the case may be, paint layer 2) in partially dried condition (residual water>10 wt. %) of a paint system with three paint layers:
   a) Application of an acrylate mixture on paint layer 1:
   On the partially dried functional layer an acrylate mixture (dipropyleneglycoldiacrylate:trimethylolpropane-trimethacrylate=4:1 with 1% azoinitiator (Type 601, produced by Wako), based on the pure acrylate mixture, acrylate amount approximately 15 μm computed as dry film) was sprayed on in an 1:1 mixture with ethyllactate. Thereafter the additional paint buildup (intermediate drying, base paint, clear coat) was completed.
   b) Application of an acrylate mixture on paint layer 2:
   The acrylate mixture and test conditions were the same as described under a). Thereafter it was as in the series process the additional paint buildup (intermediate drying, clear coat) was completed.
   c) Application of an acrylate mixture upon paint layer 3 (clear coat):
   Acrylate mixture and test conditions were the same as described under a). Thereafter, the clear coat was ventilated 15 minutes at 60° C. and final cured 30 min. at 155° C.
   Pull sheer tests of unmodified and modified samples showed for the case a) thorough c) an increase in strength of 100%.
6) Application of a paint enhancer (acrylate mixture of di- and trifunctional acrylates) on the intermediate layer (paint layer 2, as the case may be paint layer 3) in partially dried condition (residual water>10 wt. %) of a paint system with three paint layers:
   a) Application of an acrylate mixture on paint layer 2:
   On the partially dried (ventilated 2 minutes at room temperature) base paint and acrylate mixture (tricyclodecandimethanol-diacrylate; trimethylolpropanetriacrylate=4:1 with 1 wt. % azoinitiator (Type 601, produced by Wako), based on the pure acrylate mixture, acrylate amounting to approximately 15 μm computed as dry film) was sprayed on in a 1:1 mixture with ethyllactate. Thereafter, the additional paint build up was immediately completed (intermediate drying, base paint, clear coat).
   b) Application of an acrylate mixture upon paint layer 3:
   On the partially dried (ventilated 2 minutes at room temperature) clear coat the acrylate mixture described under 6a) was applied. Acrylate amount was approximately 25 μm computed as dry film. Thereafter ventilating 15 minutes at 60° C. and final curing for 30 minutes at 155° C. was carried out.
   Pull shear tests of unmodified and modified samples showed in the case a) approximately 15% and for b) approximately 20% increase of strength.
7) Application of a paint enhancer (masked isocyanate) on the partially dried paint layer 2 (residual water>10 wt. %) of a paint system with three paint layers:
   a) On the partially dried base paint a masked isocyanate (Desmodur BL 3370 MPA, amount approximately 10 μm, based on the dried film) was mixed with ethyllactate (isocyanate:ethyllactate=1:2) and sprayed on and allowed to stand 10 minutes at room temperature, in order to allow diffusion in. Thereafter the additional paint build up was completed (intermediate drying, clear coating) and final cured 30 minutes at 155° C.
   Surface pull-off tests of unmodified samples showed an increase in strength of 50%.
   b) Analogous to a), after a 2 minute ventilation of the base paint application of the paint enhancer as 1:1 mixture with ethyllactate, amount approximately 5 μm, computed based on the dry film, diffusion time: 15 minutes.
   Pull shear tests of unmodified or, as the case may be, modified samples showed an increase in strength of 30% or, as the case may be, 26%.
   The illustrative examples showed the improved mechanical toughness or, as the case may be, strength of the paint system produced in simple manner in accordance with the invention. Further, it was clear that by application of the paint enhancer upon the intermediate layer, the diffusion time could be reduced, in particular in the case of application upon the partially dried paint layers.

1-37. (canceled)

38. A process for strengthening the paint of a painted motor vehicle body part, comprising:
applying to the motor vehicle body part at least two paint layers, which are applied sequentially,
applying to at least one of the at least two paint layers of paint a strengthener for strengthening at least one of the paint layers by chemical curing.

39. The process according to claim 38, wherein the paint strengthener contains at least one cross-linkable chemical compound, which penetrates through at least one of said paint layers, and which brings about a strengthening of the paint layers through which it penetrates.

40. The process according to claim 39, wherein the paint strengthener contains at least one cross-linkable chemical compound, which penetrates through all of said paint layers, and which brings about a strengthening of the paint layers through which it penetrates.

41. The process according to claim 39, wherein the at least one cross-linkable chemical compound is an organic compound capable of a polyreaction.

42. The process according to claim 39, wherein the paint strengthener further comprises a vehicle, wherein the vehicle is a volatile solvent or a mixture of liquid solvents.

43. The process according to claim 38, wherein said at least two paint layers include one or more intermediate paint layers and a cover paint layer, wherein said paint layers are cured, and wherein the paint strengthener is applied upon the cover layer of the cured paint system.

44. The process according to claim 38, wherein said at least two paint layers include one or more intermediate paint layers and a cover paint layer, wherein the intermediate paint layers are cured, partially cured or uncured and the cover layer is partially cured, and wherein the paint strengthener is applied upon the partially cured cover paint layer.

45. The process according to claim 38, wherein said at least two paint layers include one or more intermediate paint layers and a cover paint layer, wherein the paint strengthener is applied upon one or more of the intermediate paint layers, wherein the intermediate paint layer or intermediate paint layers are at most only partially cured prior to application of the paint strengthener.

46. The process according to claim 45, wherein said paint strengthener is additionally applied upon the cover paint layer, wherein at the time of application this is likewise at most only partially cured.

47. The process according to claim 38, wherein said at least two paint layers include one or more intermediate paint layers and a cover paint layer, wherein the paint strengthener is applied upon one or more of the intermediate paint layers, and wherein the intermediate paint layer or intermediate paint layers are uncured at the time of application of the paint strengthener.

48. The process according to claim 47, wherein the paint strengthener is additionally applied upon the paint cover layer, wherein at the time of application this likewise is uncured.

49. The process according to claim 38, wherein at least one of said paint layers is a cover layer, wherein said paint strengthener is applied onto said cover layer, wherein said paint strengthener contains at least one cross-linkable chemical compound which penetrates through at least said cover layer and which brings about a strengthening of the paint layers through which it penetrates.

50. The process according to claim 49, wherein said least one cross-linkable chemical compound penetrates through all said layers.

51. The process according to claim 49, wherein the at least one cross-linkable chemical compound is an organic compound capable of a polyreaction.

52. A motor vehicle body part coated with at least two sequentially applied paint layers, with at least one cured area, with a paint a strengthener applied to at least one of the paint layers subsequent to said application of said paint layer in said at least one cured area, wherein the paint strengthener contains at least one cross-linkable chemical compound, which brings about a strengthening of the paint layers through which it penetrates.

53. A process for the secure joining of a motor vehicle body part to a part mounted to the motor vehicle body part, wherein the motor vehicle body part carries a paint layer in the area of the joining surface, the process including the following process steps:
(a) application of a paint strengthener upon the painted area of the motor vehicle body part, wherein the paint is partially or completely cured prior to application of the paint strengthener;
(b) allowing at least partial penetration or diffusion in of the paint enhancer into the paint layer;
(c) final curing of the paint in the area(s) treated with the paint strengthener by curing the paint strengthener by means of cross-linking of cross-linkable chemical compounds of the paint strengthener with at least one of (i) each other and (ii) cross-linkable chemical compounds in the paint;
(d) adhering the motor vehicle body part to the part to be mounted to the motor vehicle body part, wherein an adhesive is applied upon the painted joining surface of the motor vehicle body part and/or upon the joining surface of the part to be mounted to the motor vehicle body part.

54. The process according to claim 53, wherein the paint layer is built up of multiple layers.

55. The process according to claim 53, wherein the paint strengthener carries additional cross-linkable groups prior to and/or after curing, which are suited for cross-linking with corresponding cross-linkable groups of the adhesive.

56. The process according to claim 53, wherein the curing of the paint strengthener occurred partially or completely during adhesion in step d).

57. The process according to claim 56, wherein following adhesion essentially all cross-linkable groups of the paint strengthener have reacted with the cross-linkable groups of the paint strengthener, the paint and/or the adhesive.

58. The process according to claim 53, wherein the curing of the paint strengthener is triggered thermally, by moisture, UV or electron beam radiation.

59. The process according to claim 58, wherein the curing of paint strengthener and adhesive is triggered thermally.

60. The process according to claim 53, wherein the paint layer in step c) comprises 5 to 45 wt. % of its starting weight of cross-linkable chemical compounds of the paint strengthener.

61. The process according to claim 53, wherein the paint layer in step c) comprises 10 to 35 wt. % of its starting weight of cross-linkable chemical compounds of the paint strengthener.

62. The process according to claim 53, wherein the paint strengthener contains at least one solvent, which is suited to swell the paint.

63. The process according to claim 61, wherein said solvent is selected from the group including ketones esters and aromatics.

64. The process according to claim 63, wherein said solvent is selected from the group including butylacetate, ethyllactate or xylol.

65. The process according to claim 61, wherein in step c) the solvent of the paint strengthener comprises 3 to 10 wt. % of the starting weight the paint layer.

66. The process according to claim 54, wherein that the paint strengthener in the case of multi-layered paint layers in step c) penetrates through at least the uppermost layer.

67. The process according to claim 66, wherein that the layers of paint located below the uppermost layer comprise at least 3 wt. % based on their starting weight of cross-linkable chemical compounds of the paint strengthener.

68. The process according to claim 38, wherein the paint strengthener includes at least one organic cross-linkable compound selected from the following groups I), II), III), IV), V), VI), VII), and VIII):
I) organofunctional alkoxysilanes of the general Formula (I):
Y—R³—Si(R²ₙ)—OR¹₍₃₋ₙ₎ (1),
wherein
n 0 or 1:
Y a residue selected from the group including CH═CH₂, NH₂, NHR⁴, NHC(O)OR⁴, N═C═O, SH, SR⁴, OR⁴, OC(O)R⁴, OC(O)CH═CH₂, OC(O)C(CH₃)═CH₂ and 2,3-epoxypropoxy:
R¹=alkyl groups with 1 to 5 C-atoms, which optionally contain an ether-oxygen, preferably methyl, ethyl, iso-propyl or methoxyethyl;
R²=alkyl groups with 1 to 8 C-atoms, preferably methyl or ethyl;
R³=linear or branched, in certain cases cyclic, alkylene groups with 1 to 12 C-atoms, optionally with aromatic components, and optionally with one or more heteroatoms, in particular nitrogen atoms;
R⁴=unsubstituted or substituted carbohydrate residue, optionally containing at least one heteroatom, with 1 to 20 C-atoms;
II) mono- or multifunctional (meth)acrylates;
III) multifunctional isocyanates, masked multifunctional isocyanates;
IV) cyanacrylates;
V) multifunctional hydrazides;
VI) multifunctional carbodiimides;
VII) multifunctional epoxides;
VIII) partially alkylated melamine-formaldehyde resins.

69. The process according to claim 68,
wherein the (meth) acrylates are monofunctional (meth)acrylates are selected from the group consisting of THF-(meth)acrylates and/or isobornyl(meth)acrylate;
wherein the polyfunctional (meth)acrylates are selected from the group consisting of dipropylenglycoldiacrylate, tripropylenglycol-diacrylate, tricyclodecandimethanol-diacrylate, ethoxylated bisphenol-A-diacrylate, ethoxylated bisphenol-A-dimethacrylate, trimethylolpropane-trimethacrylate, trimethylpropane-triacrylate, tris(2-hyroxyethyl)-isocyanurate-triacrylate, ethoxylated trimethylolpropane-triacrylate, di-trimethylolpropane-tetraacrylate and/or pentaerythritol-tri- or tetraacrylate, dipentaerythritol-tetraacrylate, dipentaerythritol-pentaacrylate;
wherein the polyfunctional isocyanates are polyisocyanates masked with methylethylketoxim, diethylmalonate, 3,5-dimethylpyrazol or caprolactam, and/or self cross-linking masked polyisocyanates;
wherein the cyanacrylates are cyanoethylacrylate;
wherein the multifunctional hydrazides are carbohydrazide and/or adipic acid dihydrazide;
wherein the alkoxysilane are selected from the group consisting of 3-isocyanatopropyl-trimethoxysilane, 3-isocyanatopropyl-triethoxysilane, 3-mercatopropyl-trimethoxysilane, 3-mercatoopropyl-triethoxysilane, 3-octanoylthio-1-propyltriethoxysilane, 3-aminopropyl-trimethoxysilane, 3-aminopropyl-triethoxysilane, N-(2-aminoethyl)-3-aminopropyltrimethoxysilane and tris-[3-(trimethoxysilyl) propyl]-isocyanurate; and
wherein the organic cross-linkable compounds of group VIII) are low molecular weight, water soluble types.

70. The process according to claim 68, wherein the organic cross-linkable compounds of group VIII) are blends of partially alkylated melamine resin with OH-functional, multifunctional acrylates and dioles.

71. A multilayer paint layer configuration on a motor vehicle body part with post-cured paint layer areas, obtained by the process steps
(a) applying a paint enhancer upon the paint layer area to be post-cured;
(b) allowing penetration or diffusion in of the paint strengthener in this area of the paint layer;
(c) allowing curing the paint strengthener by cross-linking of cross-linkable chemical compounds of the paint strengthener to each other and/or with cross-linkable chemical compounds in the paint.

72. The multilayer paint configuration according to claim 71, wherein the post-cured paint layer exhibits in the post-cured areas at least one of:
(a) an increase in pull shear strength of 20%-100% in comparison to a not post-cured paint layer, and
(b) an increase in tear off resistance or peel resistance of 20%-60% in comparison to a not post-cured paint layer.

73. The multilayer paint configuration according to claim 71, wherein the post-cured paint layer exhibits in the post-cured areas at least one of
(a) an increase in pull shear strength of 20%-50% in comparison to a not post-cured paint layer, and
(b) an increase in tear off resistance or peel resistance of 20%-40% in comparison to a not post-cured paint layer.

74. The multilayer paint configuration according to claim 71, wherein the post cured areas exhibit the same optical appearance as the not post cured paint areas.
